(19) United States
(12) Patent Application Publication
(10) Pub. No.: US 2024/0400432 A1
(43) Pub. Date: Dec. 5, 2024

(54) SLUDGE DEWATERING SYSTEM HAVING A FILTRATION PANEL WITH A DIMPLED CORE

(71) Applicant: PARK ENVIRONMENTAL EQUIPMENT, LLC, Houston, TX (US)

(72) Inventor: Carl Russell CAUGHMAN, JR., Houston, TX (US)

(21) Appl. No.: 18/731,604

(22) Filed: Jun. 3, 2024

Related U.S. Application Data
(63) Continuation-in-part of application No. 17/231,146, filed on Apr. 15, 2021.
(60) Provisional application No. 63/010,151, filed on Apr. 15, 2020.

(51) Int. Cl. C02F 11/121

(52) U.S. Cl. CPC C02F 11/121

(57) ABSTRACT

A sludge dewatering system has a container, at least one filtration panel positioned in the interior volume of the container, and a frame affixed over a portion of the filtration panel. The filtration panel includes a core having a generally planar surface and a plurality of dimples extending outwardly of the generally planar surface. A filter media is overlies the plurality of dimples of the core. The frame is adapted to secure the filter media over the core.

### CROSS-REFERENCE TO RELATED APPLICATIONS

The present application claims priority from U.S. patent application Ser. No. 17/231,146 filed on Apr. 15, 2021 and entitled “Sludge Dewatering System”, presently pending. U.S. patent application Ser. No. 17/231,146 claimed priority from U.S. Provisional Patent Application No. 63/010,151, filed on Apr. 15, 2020, and entitled “Sludge Dewatering System”.

### BACKGROUND OF THE INVENTION

The present invention relates to systems that remove water from sludge. More particularly, the present invention relates to transportable containers that allow sludge to be transported to a landfill. The present invention also relates to sludge filtration systems that effectively remove water from the sludge. Additionally, the present invention relates to support structures for filter media used in such sludge filtration systems.

The term “sludge” is usable to refer to a variety of solid-liquid mixtures, including slurries, emulsions, or any similar mixture, such as sewage, industrial waste, or contaminated mud. A sludge can contain any number of liquid or solid components, and can have any ratio of liquid to solid. Typically, a sludge has somewhat more liquid than solid material contained therein. Due to the inherent properties of solid-liquid mixtures, many difficulties exist related to their handling, treatment, disposal.

Environmental regulations require that prior to disposal of a sludge in a landfill, the water content of the sludge should be reduced to an acceptable level. Additionally, a solid-liquid mixture containing a significant quantity of liquid is considered heavier than a mixture from which some or all of the liquid has been removed. This causes transport of the mixture to be difficult and cumbersome. Often, freight carriers and other transporters of a sludge, or similar solid-liquid mixture, assess costs based on the weight of the material transported. Also, water (when separated from the solids) can be easily discharged into a sewer at little or no cost. When the sludge is drier, it is cheaper to haul and also cheaper and easier to dispose. As such, a need has developed to provide a drier product from sludge.

To facilitate efficient and less expensive transport and disposal of solid-liquid mixtures, while complying with environmental regulations, various types of solid-liquid separators have been used to remove the liquid components of the mixture from the solid media. Additionally, the separation of the solid-liquid mixtures has many noteworthy industrial applications where it is desirable to retain one or more solid or liquid components for treatment, analysis, processing or use.

Generally, separation of a solid-liquid mixture is accomplished through filtration, using either pressure drainage or gravitational drainage. Vacuum drainage requires use of an on-site pump to draw liquid through a filter. This necessitates the use of a filtrate cavity that remains beneath the surface of the liquid throughout the filtering process. The force of the pump draws solid particles, as well as the liquid portion of the mixture, toward the filter. This can cause blockage of the filter and reduce the speed and efficiency of the separation process. The solid cake tends to stick to the filter when dumping.

Gravitational drainage involves simply placing a solid-liquid mixture into a container having one or more filters therein and allowing gravity to pull the liquid through the filters while the solid material is retained. The solid-liquid mixture is normally flocculated using one or more suitable polymers prior to filtration. This facilitates the separation of the mixture. Often, a number of polymers are tested against a waste source or other source of the solid-liquid mixture to determine which polymer will be the most effective for flocculating the mixture. Since no vacuum pumping is required for gravitational drainage, it is not necessary to retain the filtrate cavity beneath the liquid level of the sludge. Filters extending throughout the entire height of the container can be used to maximize surface area for the separation process and minimize the potential for blockage of filter.

However, gravitational drainage is an extremely slow process. Additionally, due to uneven distribution of the sludge within a container, and uneven rates of drainage for different portions of the sludge, it is common for large quantities of liquid to be retained in certain portions of the container for significant length of time while other portions of the liquid are separated more rapidly. Additionally, it is known that the liquid will tend to accumulate at the bottom of the container by virtue of gravity and the internal structures of the container. Typically, the filtration panels are supported by a frame that has a lip or a bar extending upwardly from a bottom of the container. As such, during the filtration process, a pool of water will tend to accumulate in this area within the container. Since landfill regulations restrict the amount of water that can be discharged into the landfill, it is important to be able to transport the sludge while avoiding the accumulation of a pool of liquid at the bottom of the container.

In the past, various patents of issued with respect to sludge filtration systems. For example, U.S. Pat. No. 4,426,020, issued on Jan. 17, 1984 to Perssau et al., describes a portable container for use in handling sludge. The container has a bottom wall and enclosing the walls. The bottom wall has a drainage area for passing liquid from the sludge placed in the container. The bottom wall is shaped to direct liquid from the sludge to the drainage area.

U.S. Pat. No. 4,871,454, issued on Oct. 3, 1989 to W. G. Lott, shows a portable dumpster and slurry separating system. In particular, this is an apparatus for separating solids from a liquid of a sludge or slurry using a peristaltic pump in order to pull a vacuum on the sludge. The apparatus includes a slurry source, a slurry container receiving the slurry from the source, and a filter cage removably mounted inside the container. The filter cage includes a cage frame, a supported screen liner mounted within the cage and a filter liner removably fitted inside the liner. The container has a liquid drainage conduit removably connected to a suction device for removing liquid from the drainage chamber. The container is constructed and adapted to be picked up, carried about, and tilted to remove solid material deposited within the filter cage. This system precludes the ability to pull a vacuum on the cake. Since it employs the cage, it is impossible to pull the vacuum.

U.S. Pat. No. 4,975,205, issued on Dec. 4, 1990 to A. H. Sloan, provides an apparatus for receiving, draining and disposing of dredged material. A dump truck is provided that has a tiltable dump body with a tailgate at a rear end thereof. A partition or weir is mounted in the dump body and is of lesser height than the walls of the dump body so as to divide the dump body into front and rear compartments. A siphon is connected between the two compartments and extends over the partition. The rear compartment receives dredged material in the form of a mixture of water and sand pumped thereinto through a supply conduit on the dump body. As the rear compartment is being filled with dredged material, gravity causes the sand to settle at the bottom and the water to rise to the top and spill over the partition into the front compartment.

U.S. Pat. No. 5,232,599, issued on Aug. 3, 1993 to C. M. Cole, describes a device and method for preparing sludge for disposal. This device comprises a box with a thin layer of gravel on the bottom and a thin layer sand on the gravel layer. There is an array of perforated piping deployed throughout the gravel layer. A sump is located in the gravel layer before the purpose perforated pipe array. Standpipes connect the array and sump to an external ion exchanger/fine particulate filter and a pump. Sand is deposited on the sand layer and dewatered using a pump connected to the piping array.

U.S. Pat. No. 5,589,081, issued on Dec. 31, 1996 to R. B. Harris, teaches a divided phase separator for liquid/solid separation in sludge. The separator tank has a bed with a drain, surrounding sides and a dividing wall. A grate overlays the interior of the vessel, bed and sides so as to form the dividing wall. A filter overlays the grate, extending up from the sides and overlapping the side grate and covering the dividing wall. The separator is filled with a sludge which is then separated from the liquid by gravity and hydrostatic pressure so as to force the liquid through the filter. Liquid is strained out of the bottom of the vessel and the solids are transported within the vessel. The solids are removed through a gate that may be provided in the tank or by using a hydraulic lift system. The filter is dumped along with the solid cake.

U.S. Pat. No. 5,681,460, issued on Oct. 28, 1997 to the present inventor, shows a selectively removable sludge filtration system that provides for retrofit into a container and separation of the sludge solids from the sludge liquids therein. A pair of spaced vertically-oriented filter assemblies each define a filtrate cavity therein that are connected by separator plates. The filter assemblies permit the flow of sludge liquids into the filtrate cavity. A set of fasteners hold the filter assemblies in the container and bias the filter assemblies against the container bottom. The fasteners may be released to provide for removal of the sludge filtration system from the container.

U.S. Pat. No. 6,146,528, issued on Nov. 18, 2000 to the present inventor, discloses a sludge filtration system that includes a container, a first filter assembly defining a first filtrate cavity, a first device for evacuating the sludge filtrate from the first filtrate cavity, and a device for selectively slidably removing the first filter assembly from the container. The container can be either an open-top box or a vacuum box that is constructed to receive sludge therein. The system further includes a second filter assembly defining a second filtrate cavity. The second filter assembly is attached to the first filter assembly and extends from the first filter assembly in a direction distal to the bottom of the container.

U.S. Pat. No. 7,179,377, issued on Feb. 20, 2007 to the present inventor, discloses a sludge filter that is comprised of mesh filter media secured to a support net. The support net includes a front surface adjacent to the filter media and a rear surface opposite the filter media. The rear surface has a plurality of outwardly extending nodes to define flow channels for horizontal and vertical fluid flow intermediate the net and a container surface. The sludge filter is attached directly to the walls or floor of the container.

U.S. Pat. No. 7,820,045, issued on Oct. 26, 2010 to the present inventor, describes a filter for sludge filtration. The sludge filter is comprised of a mesh filter media secured to a support net. The support net includes a first surface adjacent the filter media and a rear surface opposite the filter media. The rear surface has a plurality of outwardly extending nodes to define flow channels for horizontal and vertical fluid flow intermediate the net in a container surface. The sludge filter is attached directly to the walls or floor of a container. A border of the sludge filter comprises one part of a two-part fastener system with a second part of the two-part fastener system attached to a container along the perimeter of the filter coverage area so that the filter medium be removably attached to the container. U.S. Pat. No. 9,034,010, issued on Oct. 13, 2010 to the present inventor, describes a method for filtering sludge solids from sludge liquids. This method utilizes a sludge filter comprised of a rigid, yet deformable, filter media and a support net. The support net includes a front surface adjacent the filter media and a rear surface opposite the filter media. The rear surface has a plurality of outwardly extending nodes to define flow channels for horizontal and vertical fluid flow intermediate the net.

U.S. Pat. No. 5,858,226, issued on Jan. 12, 1999 to the present inventor, describes a selectively removable gravitational and vacuum sludge filtration apparatus and method that provides for retrofit into a container and for separation of the sludge solids from the sludge liquids therein. A pair of spaced vertically oriented filter assemblies each define a filtrate cavity therein and are connected by separator plates. The filter assemblies permit the flow of sludge liquids into the filtrate cavity, but not the sludge solids. A separator divides each filtrate cavity into two cavity sections, a first filtrate cavity and a second filtrate cavity. Filtrate drains into the first and second filtrate cavities by either vacuum or gravitational drainage, depending on the level of sludge within the container. Vacuum drainage occurs in the first or second filtrate cavity if either cavity is situated below the level of sludge within the container. A first and second filtrate evacuation means provides for the evacuation of filtrate from the first and second filtrate cavities by the use of a vacuum pump. A set of fasteners hold the filter assemblies in the container and bias the filter assemblies against the container bottom. The fasteners may be released to provide for removal of the sludge filtration system from the container.

U.S. Patent Application Publication No. 2006/0011561, published on Jan. 19, 2006 to Brouillard et al., provides a mobile filtration system having a floor panel and a plurality of wall panels connected to each other so as to define a box. At least one filtering wall is vertically inclined and supported inward of a corresponding wall panel so as to define a first free space therein. A filtering floor is horizontally inclined and supported above the floor panel so as to define a second free space therebetween. The filtering floor is connected to a filtering wall to define a filter chamber, a plurality of openings defined in the filtering wall. The filtering floor is sized to let a liquid pass through and retain at least one target solid within the filter chamber.

U.S. Patent Application Publication No. 2010/0206817, published on Aug. 19, 2010 to D. D. Dieziger, shows a settling tank for dewatering a thin slurry provided in a lined portable container. The settling tank is transported and dumped without requiring the transferring of residue sludge or the cleaning of equipment. This sludge is processed by settlement of the solid phase and removal of the liquid phase in cycles so as to avoid the clogging of the filter.

U.S. Patent Application Publication No. 2010/0243575, published on Sep. 30, 2010 to C. J. Nowling, teaches a separation system for separating solid-liquid mixture. A polymer solution is mixed and combined with the solid-liquid mixture to flocculate the solid-liquid mixture. The solid flocculated solid-liquid mixture is then flowed into the separation apparatus. A liquid-permeable filtration member is disposed over the floor, one or more exterior walls, and any interior dividing wall for retaining solid media within the apparatus while permitting liquids to pass. A controllable distribution system having a plurality of individually actuatable inlets is oriented to provide the solid-liquid mixture to discrete areas and to selectively maximize the efficiency of the separation process.

The present Applicant has filed U.S. patent application Ser. No. 17/231,146 relating to a sludge dewatering system. In this sludge dewatering system, the support structure for the filter media was an expanded metal panel. After tests with the structure, it was found that this expanded metal panel added weight to the overall structure of the sludge dewatering system. Since this expanded metal panel is made of a metallic material, it tended to rust during use. This is particularly true considering the corrosive elements to which such expanded metal panel is exposed during normal use. This expanded metal panel also occupied a relatively large amount of space within the container. As such, a need developed so as to reduce the weight of the container of the sludge dewatering system, to avoid rust within the support structure for the filter media, and to provide for a more usable volume of the dewatering container. It also provides a less expensive container by using cheaper parts and using less labor.

It is an object of the present invention to provide a sludge dewatering system that utilizes vertical filtering of the sludge.

It is also an object of the present invention to provide a sludge dewatering system that avoids the problems associated with bottom filters, such as clogging and cake sticking.

It is an object of the present invention to provide a sludge dewatering system which avoids standing water in the cake at the bottom.

It is another object of the present invention to provide a sludge dewatering system that increases the usable area of the filters.

It is another object of the present invention to provide a sludge dewatering system that offers a more usable volume.

It is another object of the present invention to provide a sludge dewatering system which results in a drier cake.

It is another object of the present invention to provide a sludge dewatering system that facilitates the dumping of the cake.

It is another object of the present invention provide a sludge dewatering system that has a non-stick and abrasion-resistant surface that facilitates the ability of the cake to slide out of the container.

It is another object of the present invention to provide a sludge dewatering system that protects the floor of the container.

It is still another object of the present invention provide a sludge dewatering system which allows water to pass unimpeded to the drain holes.

It is still further object of the present invention provide a sludge dewatering system that avoids dumping water in violation of landfill regulations.

It is another object of the present invention to provide a sludge dewatering system which reduces the weight of the container.

It is another object of the present invention provide a sludge dewatering system which avoids rust for the support structure of the filter panels.

It is another object of the present invention to provide a sludge dewatering system that increases the usable volume of the dewatering container.

It is still a further object of the present invention to provide a sludge dewatering system that allows for the use of an angle surface adjacent the bottom so as to eliminate standing water.

These and other objects and advantages of the present invention will become apparent from a reading of the attached specification and appended claims.

### SUMMARY OF THE INVENTION

The present invention is a sludge dewatering system that comprises a container having an interior volume and a floor, at least one filtration panel positioned in the interior volume of the container, and a frame affixed over a portion of the filtration panel and adapted to secure the filtration panel in a position within the container. The filtration panel includes a core having a generally planar surface and a plurality of dimples extending outwardly of the generally planar surface. A filter media is positioned over the plurality of dimples of the core. The frame is adapted to secure the filter media over the core.

The filter media extends from a top to a bottom of the filtration panel. The filter media has a portion extending downwardly beyond the bottom of the core. A filter support is positioned below the core and resides against a portion of the filter media extending downwardly beyond the bottom of the core. A perforated panel is affixed under that portion of the filter media extending downwardly beyond the bottom of the core. The perforated panel is affixed to the frame. In the preferred embodiment the present invention, the perforated panel and the filter support extend an obtuse angle with respect to the core. The core extends generally vertically within the interior of the container. The frame extends across a top of the core and the filter media and along at least one side of the filter media.

In the present invention, the filtration panel can be positioned within the container in a location between the side walls of the container so as to extend between the ends of the container. In such a configuration, the filtration panel comprises a first filtration panel positioned so as to extend in parallel spaced relationship between the side walls of the container. This first filtration panel has a center sheet. The core comprises a first core panel positioned on one side of the center sheet and a second core on an opposite side of the center sheet. The filter media comprises a first filter media positioned over a surface of the first core opposite the center sheet and a second filter positioned over the second core on a side of the second core opposite the center sheet. A first perforated plate is affixed under portion of the first filter media extending below the first core. A second perforated plate is affixed under a portion of the second filter media extending below the second core. A square tubing is positioned between the first perforated plate and the second perforated plate and also between the first filter media and the second filter media.

Within the preferred embodiment the present invention, there is also a second filtration panel positioned in parallel spaced relationship between the first filtration panel and one of the side walls of the container. The first filtration panel and the second filtration panel are in evenly spaced relation, respectively, to adjacent side walls of the container.

Specifically, the present invention, each of the side walls of the container can have a filtration panel thereon. As such, the first filtration panel is affixed to one of the side walls of the container such that the core is affixed to the side wall and the plurality of dimples extend in a direction away from the side wall. The second filtration panel is affixed to another of the side walls of the container such that the core is affixed to this another side wall and the plurality of dimples extend in a direction away from this another side wall.

The present invention, the core is formed of a generally polymeric material. Each of the plurality of dimples has a generally frustoconical configuration with a wide diameter at the generally planar surface. An end of the plurality of dimples opposite the generally planar surface is a flat surface. The filter media bears against this flat surface. At least one plastic panel overlies the floor of the container.

The present invention is also a filtration panel for a sludge dewatering system. This filtration panel includes a dimpled core having a plurality of dimples extending outwardly of a generally planar surface, a filter media extending over the dimpled core such that the plurality of dimples support the filter media in spaced relation to the generally planar surface, and a frame affixed over the filter media and the dimpled core.

In the filtration panel of the present invention, the filter media has a portion extending downwardly beyond the dimpled core. The filtration panel further includes a perforated panel underlying the portion of the filter media extending downwardly beyond the dimpled core. A filter support extends from below the dimpled core downwardly at a generally obtuse angle with respect to the dimpled core. The filter support supports the filter media thereon. The perforated panel overlies the filter support.

This foregoing Section is intended to describe, with particularity, the preferred embodiment of the present invention. It is understood that modifications to this preferred embodiment can be made within the scope of the present invention without departing from the true spirit of the present invention. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is an upper perspective view of the sludge dewatering system of the present invention showing an end wall in a closed position.

FIG. 2 is an upper perspective view of the sludge dewatering system of the present invention showing the end wall of FIG. 1 in an open position.

FIG. 3 is a detailed view showing the circled area “3” of FIG. 2.

FIG. 4 is a side elevational view of the filtration panel of the present invention.

FIG. 5 is a detailed view showing boxed area “5” of FIG. 4.

FIG. 6 is an upper perspective view of a portion of the filtration panel shown in FIGS. 4 and 5.

FIG. 7 is a side elevational view of another filtration panel in accordance with the present invention.

FIG. 8 is a magnified view showing the boxed area “8” of FIG. 6.

FIG. 9 is a frontal view showing the dimpled core of the present invention.

FIG. 10 is a cross-sectional view of the dimpled core as taken across lines 10-10 of FIG. 8.

FIG. 11 is a magnified view of the dimples of the dimpled core and showing the boxed area “11” of FIG. 10.

### DETAILED DESCRIPTION OF THE INVENTION

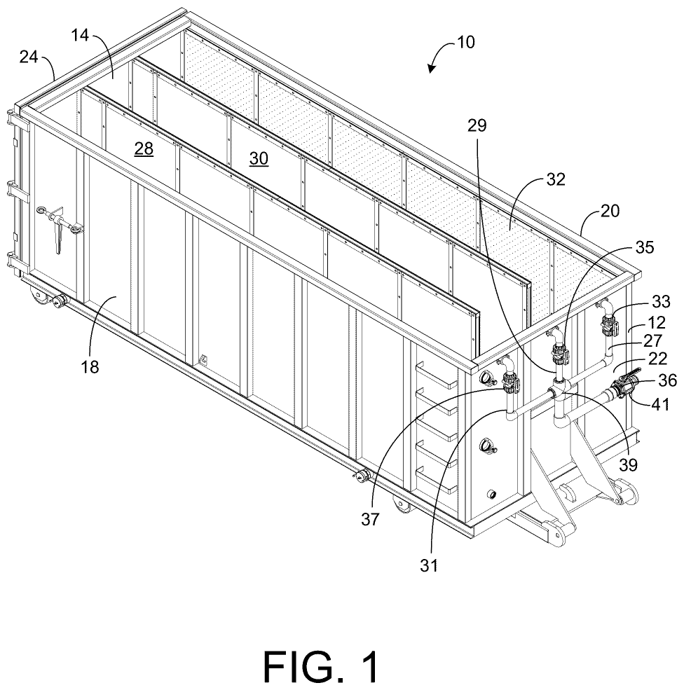

Referring to FIG. 1, there is shown the sludge dewatering system 10 of the present invention. Sludge dewatering system 10 includes a container 12 having an open top 14 and a floor (not illustrated in FIG. 1). The container 12 has side walls 18 and 20 and end walls 22 and 24. End wall 22 is illustrated as being hingedly connected the container 12 so as to open and close. FIG. 1 shows that the end wall 12 is in a closed position so as to contain the contents within the interior 14 of the container 12. A sludge inlet 26 is illustrated as affixed to the end wall 22.

In FIG. 1, it can be seen that the filtration panels 28 and 30 are illustrated as extending upwardly from the floor of the container 12. Filtration panels 28 and 30 are illustrated as extending for almost the entire height and length of the container 12. The filtration panels 28 and 30 are illustrated as evenly spaced, respectively, from the side walls 18 and 20 of the container 12. A filtration panel (not illustrated in FIG. 1) can be affixed to the inner side of side wall 18. Another filtration panel 32 is affixed to the inner side of the side wall 20. FIG. 1 particularly illustrates a pair of filtration panels 28 and 30. However, within the concept of the present invention, a single filtration panel (such as filtration panels 28 and 30) can extend between the side walls 18 and 20 of the sludge dewatering system 10.

The sludge dewatering system 10 is adapted to be suitably placed on a bed of the truck for delivery to a landfill. The sludge dewatering system 10 can also be trailer-mounted or positioned on a hydraulic dump stand. The system can be used on trailer-mounted or on tipping stand-mounted units. Within the concept of the present invention, the plurality of filtration panels 28, 30 and 32 could include only a single central filtration structure positioned centrally of the container or more than two filtration panels positioned between the side walls 18 and 20. The sludge dewatering system 10 can also be placed into a front loader (as opposed to the roll-off described hereinabove).

FIG. 1 shows that the sludge inlet 26 is used for the delivery of sludge into the interior of the container. The sludge inlet 26 includes a first sludge inlet 27 a second sludge inlet 29 and a third sludge inlet 31. Sludge inlets 27, 29 and 31 open to the interior 14 of the container 12 so as to deliver sludge independently into each of the chambers defined on the interior 14 of the container. These chambers are defined by the space between the side wall 18 and the first filtration panel 28, the space between the first filtration panel 28 and the second filtration panel 30, and the space between the second filtration panel 30 and the side wall 20. The first sludge inlet 27 has a first throttling valve 33 thereon. The second sludge inlet 29 has a second throttling valve 35 thereon. The third sludge inlet 31 has a third throttling valve 37 thereon. The throttling valves 33, 35 and 37 control the flow of sludge into the interior of the container. An inlet manifold 39 is connected to the first sludge inlet 27, the second sludge inlet 29 and the third sludge inlet 31. A swivel fitting can support the manifold 39 in its connection to the sludge inlets. Sludge inlet 26 has a shut-off valve 41 thereon.

The sludge inlet 26 of the present invention controls the flow of sludge into the container 12. The flow can be evenly distributed into the three internal chambers by operating the throttle valves installed on the inlet manifold 39. The shut-off valve at the end of the manifold is closed when disconnecting the sludge feed line. This serves to prevent spills. A groove-type clamp attaching the inlet arm to the main manifold allows the arm to swing to either side so as to facilitate the ability of the present invention to adapt to the location of sludge feed. When a single central filtration structure is used, the sludge inlets will open the chambers formed on opposite sides of the central filtration structure. Whenever a single central filtration structure is used, there would only be a sludge inlet on one side of the central filtration structure and another sludge inlet on opposite side of the central filtration structure.

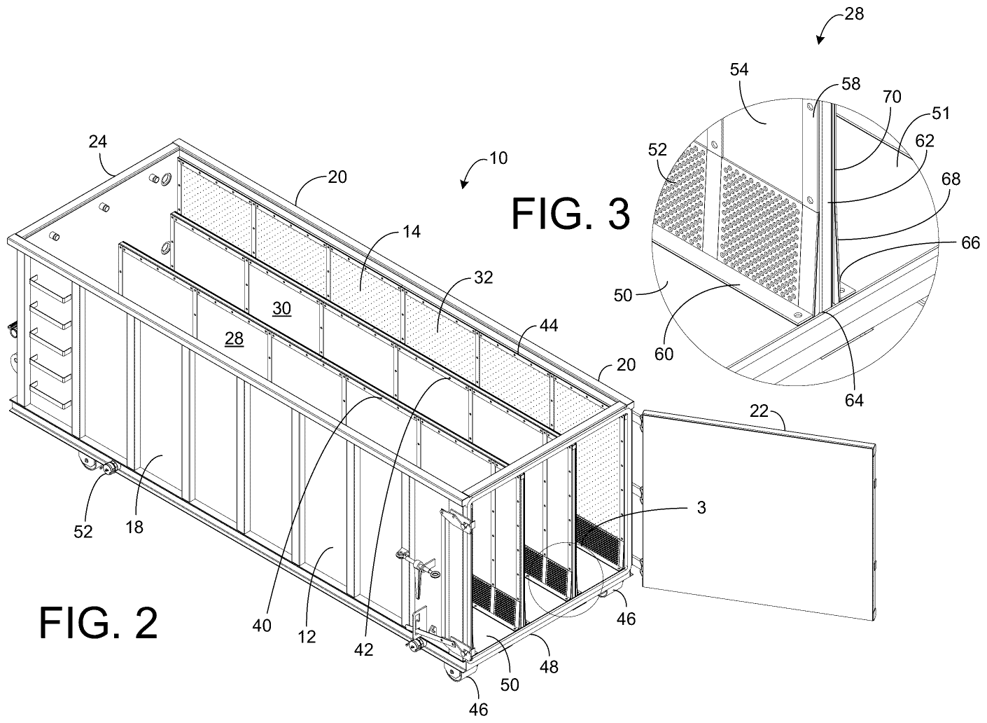

FIG. 2 shows the sludge dewatering system 10 of the present invention with the end wall 22 in an open position. In particular, the end wall 22 is hinged to the side wall 20 of the container 12. The end wall 22 can open so as to expose the interior 14 of the container 12. FIG. 2 shows, in particular, the configuration of the side wall 18, the end walls 22 and 24 and the side wall 20. The filtration panels 28 and 30 are illustrated as positioned within the interior 14 of the container 12.

FIG. 2 shows the structure of the filtration panels 28 and 30. A detailed view of this construction is shown in FIG. 3. In FIG. 2, it can be seen that there is a frame 40 that extends around the filtration panel 28 and another frame 42 that extends around the filtration panel 30. A further frame 44 will extend around the filtration panel 32. The frames 40, 42 and 44 serve to maintain each of the filtration panels 28, 30 and 32 in a vertical orientation within the interior 14 of the container 12. In particular, the filtration panels 28 and 30 are illustrated as being generally evenly spaced between the side walls 18 and 20. Rollers 46 are affixed to the bottom 48 of the container 12 so as to facilitate the ability of the container 12 to roll on and roll off a truck bed, or other structure, as required.

The container 12 has a floor 50 positioned at the bottom 48 of the container 12. Floor 50 can have at least one plastic panel thereon. In the preferred embodiment of the present invention, there are a plurality of plastic panels that are positioned on the floor 50 and extend between the respective filtration panels. The plastic panels 50 will overlie a bottom channel adjacent the bottom 48 of the container 12. This will allow any liquids that are being dewatered from the sludge to pass therefrom and outwardly through discharge outlet 52. As will be described hereinafter, the plastic panels 50 will typically overlie the filter media at the edges adjacent to each of the panels 28, 30 and 32 (along with the filtration panel attached to the inner wall of side wall 18).

Each of the filtration panels 28, 30 and 32 (along with the filtration panel attached to the inner wall of side wall 18) will has a unique configuration. FIG. 3 shows the circle area “3” of FIG. 2 so as to specifically show the structure adjacent the bottom of the central filtration panels 28 and 30.

FIG. 3 shows the filter media 54 along with an exposed perforated plate 56 positioned at a lower portion of the filtration panel. In FIG. 3, the filter media 54 is illustrated as exposed in the areas of the perforated plate 56. In actual use, the filter media 54 will extend down over the perforated plate 56 so as to have a small portion residing over the flat bar 60. The plastic panels 50 (shown in FIG. 2) will then overlie a small horizontal portion of the filter media 54 that projects outwardly beyond the bottom of the perforated plate 56. The plastic panel 50 will then get bolted to the floor so as to trap the edge of the filter underneath it.

The flat bar 58 is part of the frame 44 that supports the filtration panel 28. Another flat bar 50 will extend below the lower portion of the filter media 54 and across the bottom of the perforated plate 56. The plastic panel 50 will then overlie the flat bar 60 and extend across the floor of the container 12. Plastic panel 50 will also overlie a small outwardly and horizontally extend portion of the filter media 54. Square tubing 62 extends upwardly from the floor of the container and supports the structure of filtration panel 28 thereon. End 64 and 66 are positioned on opposite sides of the square tubing 62 so as to provide structural support for the perforated plate 56 and the filter media 54. Another perforated panel 68 will underlie filter media 70 located on the opposite side of the square tubing 62. Plastic panel 51 can then overlie and outwardly horizontally extending portion of the filter media 54 that extends outwardly of the perforated panel 68 on the opposite side of the square tubing 62.

The perforated plates 56 and 68 are bolted to a support at the bottom below a dimpled core so as to jut out away from the wall plate approximately three inches. This allows the two inch wide drainage port (located between the perforated plates of 56 and 68) to be unobstructed behind the perforated plates 56 and 68.

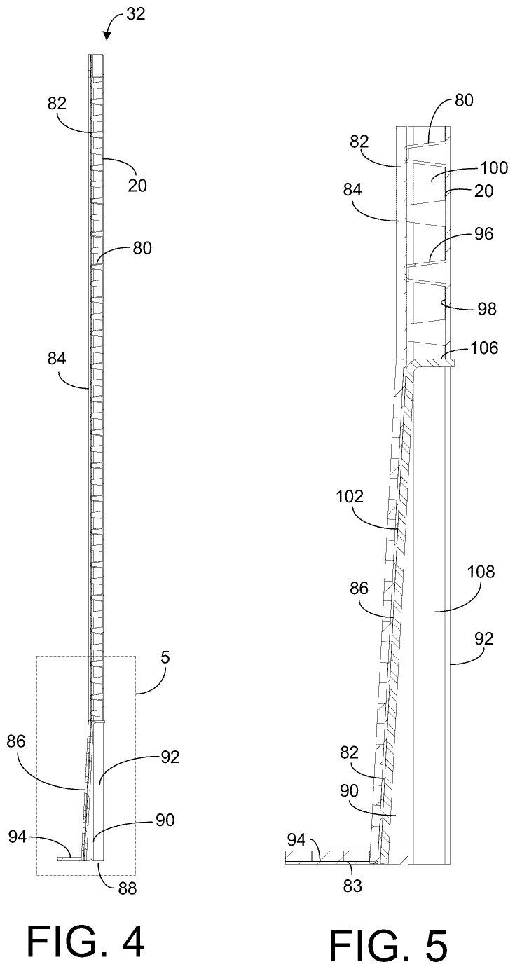

FIG. 4 illustrates the configuration of a filtration panel 32 that is affixed to the side wall 20 of the sludge dewatering system 10 of the present invention. In FIG. 4, the filtration panel 32 extends for the height of the side wall 20. In particular, FIG. 4 shows that there is a dimpled core 80 that is positioned against the inner surface of side wall 20. Dimpled core extends outwardly therefrom so as to support the filter media 82 thereon. The frame 84 extends along the side of the filter media so as to support the filter media 82 in a proper position. Ultimately, there is a portion of the filter media that extends downwardly below the dimpled core 80. A perforated plate 86 will overlie the dimpled core 80 adjacent to the bottom 88 of the side wall 20. The end cap 90 extends between the square tubing 92 and the perforated plate 86. Ultimately, there is a flat bar 94 positioned at the bottom 88 of the perforated plate 86 so as to support the filtration panel 32 in a proper position.

FIG. 5 shows the boxed area “5” of FIG. 4 in greater detail. FIG. 5 shows that the side wall 20 supports the dimpled core 80. Dimpled core 80 includes a plurality of dimples 96 that are supported upon a generally planar surface 98. The plurality of dimples 96 extend outwardly so as to bear against an inner surface of the filter media 82 thereon. As such, the plurality of dimples 96 will define a space 100 between the side wall 20 and the filter media 82. As the sludge is dewatering and liquid flows from the sludge through the filter media 82, it can travel downwardly in the space 100 so as to flow toward the bottom of the container 12. A drainage port (not shown) is positioned at the bottom of the space 100 and is unobstructed behind the perforated plate. A flat bar 84 is illustrated as bearing against an edge of the filter media 82 so as to structurally support the filter media 82 thereon.

FIG. 5 shows that the filter media 82 has a portion 102 that extends downwardly below the bottom of the dimpled core 80. This portion is supported by the perforated plate 86. The perforated plate 86 is connected to the side wall 20 by a transverse bar 106. The perforated plate 86 extends outwardly from the bottom of the dimpled core 80 and a generally obtuse angle with respect to the dimpled core 80. As such, the portion 102 of the filter media 82 (which is supported by the perforated plate 86) will also extend at the generally obtuse angle. The perforated plate 86 will underlie this lower portion 102 of the filter media 82 and will also extend at this obtuse angle. The filter media 82 has a lower portion 83 that will extend so as to make a turn where the perforated plate 86 meets the floor. The portion 83 of the filter media 82 will extend outwardly a few inches. As was described hereinafter, the plastic floor plate will be positioned over this portion 83 of the filter media 82 so as to trap this portion 83 of the filter media 82 beneath it.

Ultimately, the square tubing 92 will have an interior that acts to receive and pass the liquid flowing through the interior 100 that is defined by the distance between the filter media 82 and the side wall 20 of the container 12. Ultimately, the square tubing 108 will connect with the draining port and the channels at the bottom of the container 20 so as to allow the dewatered liquid from the sludge to be discharged from the container. A spacer bar 90 is illustrated as supporting the perforated plate 86, along with the lower portion of the filter media 82, at the obtuse angle. The flat bar 94 is positioned at the bottom of the container. The plastic panel can overlie this flat bar 94 and the portion 83 of the filter media 82 in the assembled configuration.

It should be noted that the configuration of the filtration panel 32, as illustrated in FIGS. 4 and 5, is applicable to a filtration panel that is applied to the inner wall of the side wall 18 of the container 12.

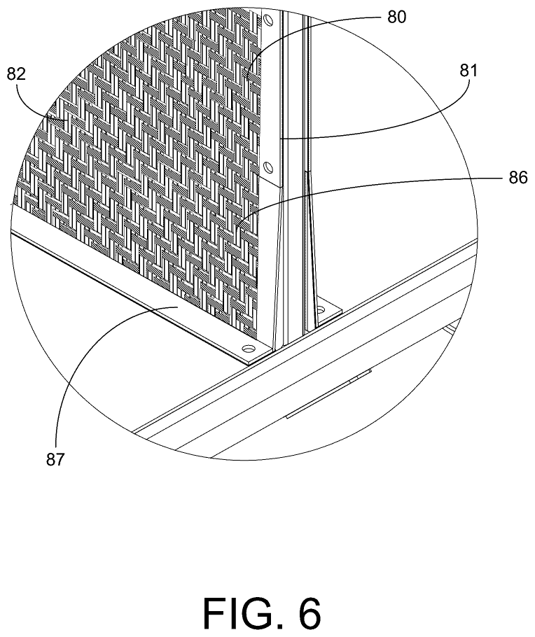

FIG. 6 shows a perspective view of the lower portion of the filtration panel. In FIG. 6, it can be seen that the dimpled core 80 will be positioned behind the filter media 82. Area 81 is the approximate line where the dimpled core 80 meets the perforated plate 86. It can be seen that the filter media 82 will overlie the dimpled core 80 and also extend at the same obtuse angle relative to the line 81 between the dimpled core 80 and the perforated plate 86. Tie-down bracket 87 is secured to the floor of the container and can be secured to the plastic panel overlying a portion of the filter media 82 at the tie-down bracket 87.

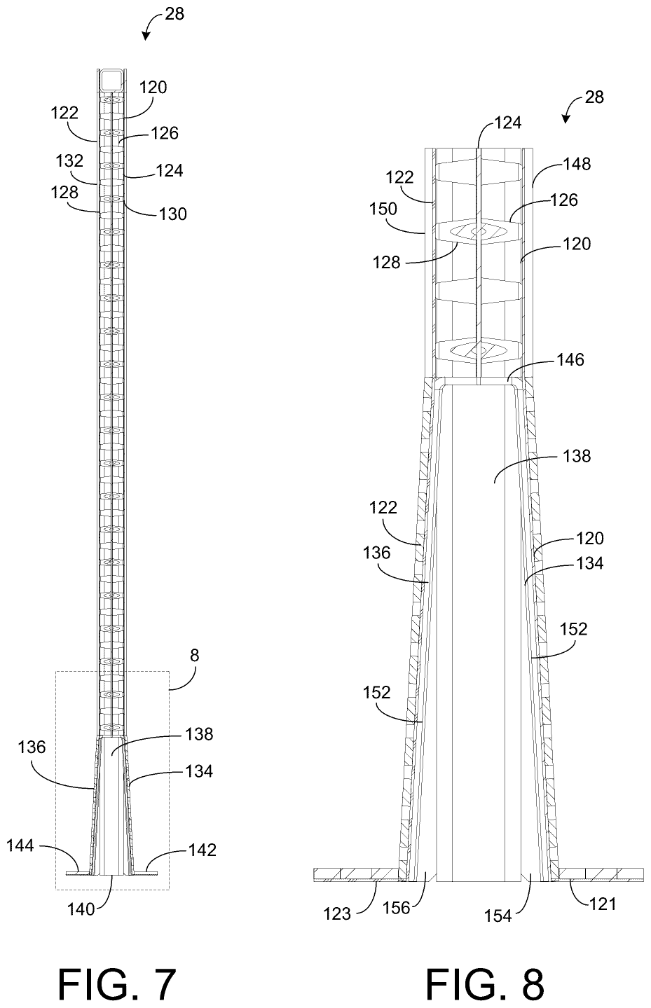

FIG. 7 illustrates, in particular, another type of filtration panel 28. As was recited herein previously, filtration panel 28 is located in a location on the interior 14 of the container 12 and located between the side walls 18 and 20 of the container. So as to facilitate and enhance the ability to dewater the sludge, the filtration panel 28 includes a first surface 120 and a second surface 122 that are adapted for filtration. In particular, there is a center wall 124 that extends in a generally vertical orientation. A first dimpled core 126 is located on one side of the center sheet 124. Another dimpled core 128 is located on opposite side of the center sheet 128. A first filter media 130 is located on the first dimpled core 126. Another filter media 132 is located on the dimpled core 128. As such, the dimpled cores 126 and 128 will support the filter media 130 and 132 in a vertical orientation in generally parallel relationship to each other. As will be described hereinafter, the dimpled cores 126 and 128 will provide a space whereby the liquids from the sludge can flow into the space between the filter media 130 and 132 so as to flow downwardly in the filtration panel 28.

Ultimately, the lower portion of the filtration panel 28 includes a first perforated panel 134 and a second perforated panel 136 (as shown in greater detail in FIG. 8). These will be supported at an obtuse angle with respect to the remainder of the filter media 130 and 132. A square tubing 138 is positioned at the bottom of the dimpled cores 126 and 128 so as to allow liquid to pass through the interior of the square tubing 138 and downwardly so as to exit through the outlet 140 at the floor of the container. The liquid can flow from there to channels located at the bottom of the container so as to ultimately be discharged from the container. Flat bars 142 and 144 serve to support the filtration panel 28 upon the floor of the container.

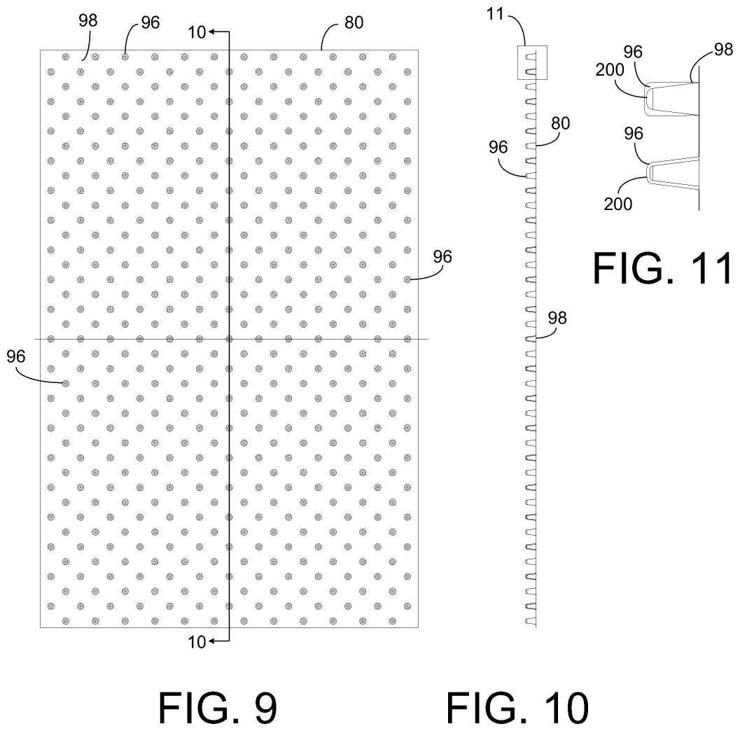

FIG. 9 is a detailed view showing the construction of the lower portion of the filtration panel 28. In FIG. 8, the central sheet 124 is illustrated as extending downwardly so as to terminate at the top of the filter support 146. The first dimpled core 126 is positioned on one side of the central sheet 124. The other dimpled core 128 is located on the opposite side of the central sheet. The dimpled cores 126 and 128 will support the filter media is 120 and 122 thereon. A flat bar 148 and a flat bar 150 serve to provide a frame for the structural integrity of the filter media 120 and 122, along with the dimpled cores 126 and 128.

The perforated plates 134 and 136 will extended an obtuse angle with respect to the dimpled cores 126 and 128. Perforated plates 134 and 136 will underlie the filter media 120 and 122. Perforated plates 134 and 136 will have a plurality of openings 152 formed therethrough. This will allow liquids to flow therethrough. The square tubing 138 is illustrated is positioned between the perforated plates 134 and 136. End caps 154 and 156 are illustrated is interposed between the square tubing 138 and the filter media. Ultimately, the filter media 120 and 122 will have portions 121 and 123 that will extend outwardly at the bottom of the filtration panel 28 at the floor of the container. The plastic panels (illustrated hereinbefore) will then overlie these portions 121 and 123 so as to be bolted to the floor of the container. As such, the portions 121 and 123 of the filter media 120 and 122, respectively, will be secured in position. This positioning of the filter media at the bottom of the container assures that any amount of sludge that is to be dewatered will continue to be filtered as it accumulates on the floor of the container. Ultimately, the water of the from the sludge will flow through the filter media, through the perforated panel, and into the square tubing 138 in order to flow to the drainage port and associated channels at the floor of the container.

The illustration of the filtration panel 28, as shown in FIGS. 7 and 8, will be identical for the filtration panel 30 (as shown in FIGS. 1 and 2).

FIG. 9 is a frontal view showing the configuration of the dimpled core 80. Dimpled core 80 has a generally rectangular configuration (although other configurations are suitable within the concept of the present invention). There are a plurality of dimples 96 that are formed along the planar surface 98 of the dimpled core 80. Each of the dimples 96, as can be seen in FIG. 9, has a generally circular cross-section. A more detailed view of each of the dimples is shown in FIG. 11. The dimples 96 are generally evenly spaced from each other across the planar surface 98 of the dimpled core 80. The dimples 96 are formed in a plurality of rows and columns and are generally offset from each other along respective pairs of the rows and columns. This will ensure a thorough flow of the water from the sludge through the filter media and into the spaces between each of the dimples 96. The dimpled core 80 can be formed of a suitable polymeric material. The dimpled core 80 can be used in association with the filtration panels that are attached to the side walls 18 and 20 of the container 12 or can be used on opposite sides of the center sheet of each of the filtration panels 28 and 30.

FIG. 10 illustrates a side view of the dimpled core 80. The dimples 96 extend outwardly of the generally planar surface 80.

FIG. 11 shows the configuration of each of the dimples 96 as positioned on the generally planar surface 98. It can be seen that each of the dimples 96 has a generally frustoconical configuration with a flat surface 200 formed opposite the planar surface 98. Ultimately, the filter media can be easily applied and secured to the flat surface 200 of each of the dimples 96. The spaces between each of the dimples 96 provides a flow path for the travel of dewatered liquids.

As used herein, there are plastic panels 50 that are positioned on the floor between the various filtration panels. These plastic panels extend for the length and width of the floor. The plastic panels can be used to secure lower end of the filter media and to allow for the accumulation of sludge cake thereon.

The obtuse angle associated with the perforated panels on each of the filtration panels of the present invention will increase the filtration area. Any sludge that resides against these filtration panels will be directed by the angled perforated panels toward the plastic panels on the floor. The increased filtered surface area and the more narrow sludge compartments formed by the filtration panels of the present invention will translate into drier cakes that are formed in less time. The plastic panels 50 that are used on the floor of the container 12 serve to facilitate the dumping of the cake. Experiments with the present invention is shown that the filter cake will flow outwardly of the container more smoothly because of the use of these plastic surfaces. The sludge filtration system 10 of the present invention is particularly adapted for bio-solids dewatering, manufacturing waste, grease trap waste, septic tank sludge, industrial sludge, mining sludge and alum sludge. The present invention can also be used without the use of those plastic panels.

In the present invention, the plastic panel will replace the volume where water could stand at the bottom of the container 12. The plastic panel also offers a non-stick and an abrasion-resistant surface. This allows the cake to slide out of the container 12 when unloading the container. The plastic panels also protect the floor of the container from damage. If any of the plastic panels should become damaged, they can be easily replaced.

Importantly, the filter media extends along the surfaces of the filtration panel and also along the outer surfaces of the angled perforated plate. The filter media extends upwardly from the angled perforated plate so as to cover the dimpled core of the filtration panel. Any water that would pool at the floor will flow directly into the filtration panel. There is no metal frame or other obstructions that would block this flow or otherwise cause the accumulation of water into the area under the outer surface of the filtration panel. The angled perforated plates, along with the filter media (positioned thereon), assures that any materials residing adjacent to the filtration panel will flow downwardly toward the panel and will avoid accumulation in a sharp corners between the filtration panel and the plastic panels and/or the floor.

Since the dimpled core is formed of a polymeric material, it will not rust. The frustoconical configuration of the plurality of dimples creates a surface over which the liquid can easily flow without accumulation. The circular cross-section of such dimples also facilitates the ability for liquid to flow thereover. The use of the polymeric material for the dimpled core serves to reduce the volume and weight of the filtration panel. As such, there is a greater usable volume within the interior of the container. The planar surface of the dimpled core can be glued or otherwise attached to the walls of the dewatering container 12. The dimpled core can be easily framed around the perimeter thereof using one inch tubing, angle or channel members. The filter can be bolted or otherwise adhesively attached to the perimeter metal and supported by the dimpled core.

The dimpled core will stop approximately twelve inches from the floor. The perforated plates are angled at approximately 20° was to extend from the end of the dimpled court core to the floor. This will kick the perforated panels out far enough to clear the hole in the floor.

The foregoing disclosure and description of the invention is illustrative thereof. Various changes in the details of the illustrated construction can be made is the scope of the present claims without departing from the true spirit of the invention. The present invention should only be limited by the following claims and their legal equivalents.

1. A sludge dewatering system comprising:
a container having an interior volume and a floor and side walls and end walls;
at least one filtration panel positioned in the interior volume of said container, said at least one filtration panel comprising:
a core having a generally planar surface and a plurality of dimples extending outwardly of the generally planar surface of said core; and
a filter media positioned over the plurality of dimples of said core; and
a frame affixed over a portion of said at least one filtration panel, said frame adapted to secure said filter media over said core.

2. The sludge dewatering system of claim 1, said filter media extending from the top to a bottom of said at least one filtration panel, said filter media having a portion extending downwardly beyond a bottom of said core.

3. The sludge dewatering system of claim 2, further comprising:
a filter support positioned below the core and residing against the portion of said filter media extending downwardly beyond the bottom of said core; and
a perforated panel affixed under the portion of said filter media extending downwardly beyond the bottom of said core.

4. The sludge dewatering system of claim 3, said perforated panel being affixed to said frame.

5. The sludge dewatering system of claim 4, said perforated panel and said filter support extending at an obtuse angle with respect to said core.

6. The sludge dewatering system of claim 1, said frame extending across a top said core and said filter media, said frame extending along at least one side of said filter media.

7. The sludge dewatering system of claim 1, said at least one filtration panel comprising:
a first filtration panel positioned so as to extend in parallel spaced relation between the side walls of said container.

8. The sludge dewatering system of claim 7, said first filtration panel having a center sheet, said core comprising a first core positioned on one side of said center sheet and a second core positioned on opposite side of said center sheet, said filter media comprising a first filter media positioned over a surface of the first core opposite the center sheet and a second filter media positioned over the second core on a side opposite the center sheet.

9. The sludge dewatering system of claim 8, further comprising:
a first perforated plate affixed under a portion of the first filter media extending below the first core; and
a second perforated plate affixed under a portion of the second filter media extending below the second core.

10. The sludge dewatering system of claim 9, further comprising:
a square tubing positioned between the first perforated plate and the second perforated plate in a location between the first filter media and the second filter media.

11. The sludge dewatering system of claim 7, said at least one filtration panel comprising a second filtration panel positioned in parallel spaced relation between the first filtration panel and one of the side walls of said container.

12. The sludge dewatering system of claim 11, the first filtration panel and the second filtration panel being in evenly spaced relation respectively to adjacent side walls of said container.

13. The sludge dewatering system of claim 1, wherein said core is affixed to one of the side walls of said container.

14. The sludge dewatering system of claim 13, wherein said at least one filtration panel comprises:
a first filtration panel affixed to one of the side walls of said container such that the core is affixed to the one of the side walls and that the plurality of dimples extending in a direction away from the one of the side walls; and
a second filtration panel affixed to another of the side walls of said container such that the core is affixed to the another of the side walls such that the plurality of dimples extend in a direction away from the another of the side walls.

15. The sludge dewatering system of claim 1, wherein said core is formed of a polymeric material.

16. The sludge dewatering system of claim 1, wherein each of the plurality of dimples has a generally frustoconical configuration with a wide diameter at the generally planar surface, an end of the plurality of dimples opposite the generally planar surface being a flat surface, said filter media bearing against the flat surface.

17. The sludge dewatering system of claim 1, further comprising:
at least one plastic panel overlying the floor of said container and overlying a lower portion of the filter media.

18. A filtration panel for a sludge dewatering system, the filtration panel comprising:
a dimpled core having a plurality of dimples extending outwardly of a generally planar surface;
a filter media extending over the dimpled core such that the plurality of dimples support the filter media in spaced relation to the generally planar surface; and
a frame fixed over said filter media and said dimpled core.

19. The sludge dewatering system of claim 18, said filter media having a portion extending downwardly beyond said dimpled core, the filtration panel further comprising:
a perforated panel underlying the portion of the filter media extending downwardly beyond said dimpled core.

20. The sludge dewatering system of claim 18, further comprising:
a filter support extending from below said dimpled core downwardly at a generally obtuse angle with respect to said dimpled core, said filter support supporting said filter media thereon, said perforated panel overlying said filter support.
